(19) United States
(12) Patent Application Publication
(10) Pub. No.: US 2020/0133711 A1
(43) Pub. Date: Apr. 30, 2020

(54) Event-Triggered Configuration of Workflow Processes for Computer Software Development Systems

(71) Applicant: Calculi Corporation, Santa Clara, CA (US)

(72) Inventors: Justin P. Webster, San Jose, CA (US); Robert Boyd, Belmont, CA (US); Eric Billingsley, Los Gatos, CA (US); Yoganarasimha Ganesha, Hayward, CA (US); Basheer Janjua, Half Moon Bay, CA (US); Pinaki Sarkar, Milpitas, CA (US); Rekha Mittal, Santa Clara, CA (US); Shweta Deshpande, San Jose, CA (US); Yael Adler, Sunnyvale, CA (US)

(21) Appl. No.: 16/671,108

(22) Filed: Oct. 31, 2019

Related U.S. Application Data
(60) Provisional application No. 62/753,864, filed on Oct. 31, 2018.

(51) Int. Cl. G06F 9/48; G06F 8/30; G06F 9/50

(52) U.S. Cl. CPC G06F 9/4806; G06F 8/60; G06F 9/50; G06F 8/30

(57) ABSTRACT

The present disclosure relates generally to software development and more particularly to methods and systems for automated configuration and execution of context-optimized software development workflow processes for software. A method can perform a pre-configuration of a software development workflow process in advance of execution of the workflow process based upon one or more sources of configuration data. The method can subsequently create an optimized workflow process configuration wherein evaluation of workflow process triggering event context data results in event-optimized workflow process configuration and execution. A system can include: a user interface through which users can interact with the system; a component that can perform pre-configuration of software development workflow processes; a component that can perform context-optimized configuration of software development workflow processes; and a component that can perform automated execution of such context-optimized software development workflow processes.

### RELATED APPLICATIONS

The subject matter of this application is related to U.S. Provisional Application No. 62/753,864, filed on 2018 Oct. 31, which is hereby incorporated by reference in its entirety.

### SUMMARY

The present disclosure relates generally to software development and more particularly to methods and systems for automated configuration and execution of context-optimized software development workflow processes for software.

A method can perform a pre-configuration of a software development workflow process in advance of execution of the workflow process based upon one or more sources of configuration data. The method can subsequently create an optimized workflow process configuration wherein evaluation of workflow process triggering event context data results in event-optimized workflow process configuration and execution.

A system can include: a user interface through which users can interact with the system; a component that can perform pre-configuration of software development workflow processes; a component that can perform context-optimized configuration of software development workflow processes; and a component that can perform automated execution of such context-optimized software development workflow processes.

The system and method can be configured to perform optimizations and improvements, distinguishable from static, pre-configured, non-context-optimized workflow processes, pertaining to for example: the initial configuration (pre- and final) of software development workflow processes; the subsequent modification and/or maintenance of previously-created workflow processes; the management, administration, and support of such workflow processes (at an organizational level); the efficiency, reliability and costs (e.g. in money, time, resources, etc.) associated with the configuration and execution of such workflow processes; and the reusability of and lifetime value of such workflow processes.

The system and method can be used in the context of software delivery, software continuous integration (CI), software continuous delivery (CD), software continuous deployment, software development pipelines, and other kinds of software automation, activities, and processes generally related to software development. CI is a software engineering practice in which developers frequently integrate code into a shared software configuration management (SCM) repository in order to obtain rapid feedback about source code quality and correctness. CI enables automated build and testing so that teams can rapidly work on a single project together. CD is a software engineering practice which extends CI and uses automation more comprehensively, including additional automation of test, configuration, release, and other development-related activities and processes. Continuous deployment describes a particular subset of CD practices and is the process by which qualified changes in software code or architecture are automatically deployed to production, without human intervention, as soon as they are verified by CD automation. Software development pipelines are a technique, commonly used in CI and CD, for using workflow automation to integrate separate kinds of automation, such as the various kinds of automation commonly used in CI and CD.

A method can be performed by a computer system having at least one processor and a memory. The method can include, the computer system: accessing context data for an event that triggers a workflow process within a computer software development system, wherein the context data include an event type for the event; accessing workflow process configuration data for a set of computer software source code, wherein the workflow process configuration data include software application configuration data and workflow process instructions; modifying the workflow process configuration data to create modified workflow process configuration data, wherein the modifying includes configuring the workflow process configuration data to implement one or more optimizations, and wherein each of the one or more optimizations is based on an evaluation of a portion of the context data; and executing an optimized workflow process run to generate one or more software artifacts based on the modified workflow process configuration data.

The context data can further include an event source for the event. The context data can further include an event time for the event. The event type can be, for example, any of: a revision to software source code; an initial configuration of the workflow process configuration data for the set of software source code; a change of a resource upon which the set of software source code depends; a scheduled event; receipt of a user-supplied instruction to initiate a workflow process; and receipt of a user-supplied instruction to restart a workflow process. The workflow process instructions can define tasks and dependencies between tasks.

The software application configuration data can include, for example, one or more of: software dependency data; configuration data for generating a software application; configuration data for testing a software application; configuration data for analyzing a software application; configuration data for releasing a software application; configuration data for deploying a software application to a particular environment; and configuration data for deploying a software application for a particular purpose.

Each of the one or more optimizations can be, for example, any of: a reordering of tasks specified to be performed by the workflow process; a parallelization of tasks specified to be performed by the workflow process; an omission of a task specified to be performed by the workflow process; an inclusion of a task not specified to be performed by the workflow process; a configuration of a task incompletely configured by the workflow process; a reuse of an artifact produced by a previously executed workflow process; a configuration of a software artifact not originally configured to be produced by the workflow process; a creation or modification of scheduling parameters affecting execution of the workflow process; and an identification or modification of resources allocated for execution of the workflow process.

The method can further include determining that the event is not an ignorable event based on the context data and the modified workflow process configuration data, and the executing of the workflow process run can be performed in response to the determining that the event is not an ignorable event. The context data for the event, the workflow process configuration data, or both can be accessed from a database. The context data for the event, the workflow process configuration data, or both can be received from a computer system.

Each of the generated software artifacts can be, for example, any of: a set of one or more deployable software applications; a set of one or more software dependencies; metrics relating to the executing of the workflow process; logs relating to the executing of the workflow process; and reports about artifacts produced by the workflow process.

The optimizations can include omitting a software deployment task from the workflow process, wherein the event that triggers the workflow process comprises a revision to software source code on a non-master branch or on a feature branch.

The optimizations can include addition and configuration of a source code analysis task to the workflow process, wherein the source code analysis task is not specified in the workflow process configuration data prior to the modifying.

The optimizations can include alteration of a scheduling priority of a task in the workflow process, wherein the event that triggers the workflow process comprises a revision to software source code, and wherein the alteration is based on an evaluation of the revision.

The optimizations can include alteration of a scheduling priority of the workflow process, wherein the event that triggers the workflow process comprises a revision to software source code, and wherein the alteration is based on an evaluation of the revision.

The optimizations can include using files cached by a separate workflow process in the workflow process based on a determination that the separate workflow process is configured to perform a task identically to the workflow process.

The optimizations can include specifying or modifying a number, a size, or a type of computing resources used to execute the optimized workflow process run.

A computer system can include at least one processor and a memory storing instructions that, when executed by the at least one processor, cause the computer system to perform the foregoing method.

A non-transitory computer readable medium can have instructions stored thereon, wherein the instructions, when executed by a computer system having at least one processor and a memory, cause the computer system to perform the foregoing method.

### BRIEF DESCRIPTION OF THE DRAWINGS

FIG. 1 illustrates a method for combining multiple sets of workflow process configuration data into corresponding unified and active configuration data.

FIG. 2 illustrates a method for the context-optimized configuration of a final workflow process configuration.

FIG. 3 illustrates a method for the context-optimized configuration of a final workflow process configuration.

FIG. 4 illustrates a method for the use and data processing of a set of workflow process configuration data, and corresponding processing of results of such processing.

FIG. 5 illustrates a method for the use and data processing of a set context data, and the corresponding processing of the results of such processing.

FIG. 6 illustrates a block diagram of a system that performs automated configuration and execution of context-optimized software development workflow processes.

FIG. 7 illustrates a general computer architecture that can be appropriately configured to implement components disclosed in accordance with various embodiments.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted.

Software development is a time consuming and resource intensive process.

Traditionally, software development has been broken down into several distinct stages, such as a specification or requirements stage, a design stage, a construction stage, and a production stage. Each stage can last weeks, months, or even years. Software development practices have recently begun to evolve to address such lengthy development lifecycles, by using software development workflow processes to manage the automation to build, test, and deploy the software. However current solutions, such as continuous integration platforms, configure and enable development workflow processes in advance, prior to the time of execution, resulting in the creation of static workflow processes. Such static workflow processes typically execute a static build script created long in advance of the time of execution. Such scripts and workflow processes are therefore non-context-optimized in that they do not have access to the data or properties of an event that triggers a workflow process. Such scripts and workflow processes are also infrequently-modified relative to the frequency of workflow process executions. As a consequence, such workflow processes are inherently subject to a variety of constraints and limitations, such as inflexibility, fragility, inefficiency, that limit their benefits. For example, since a single, static workflow process typically must be able to execute correctly for each of numerous, separate triggering events, such as source code commits, such workflow processes are often much more complex, costly, and inefficient than is required for a specific, individual trigger event.

A system can be configured to perform methods for automated configuration and execution of context-optimized software development workflow processes. The system can be configured to:

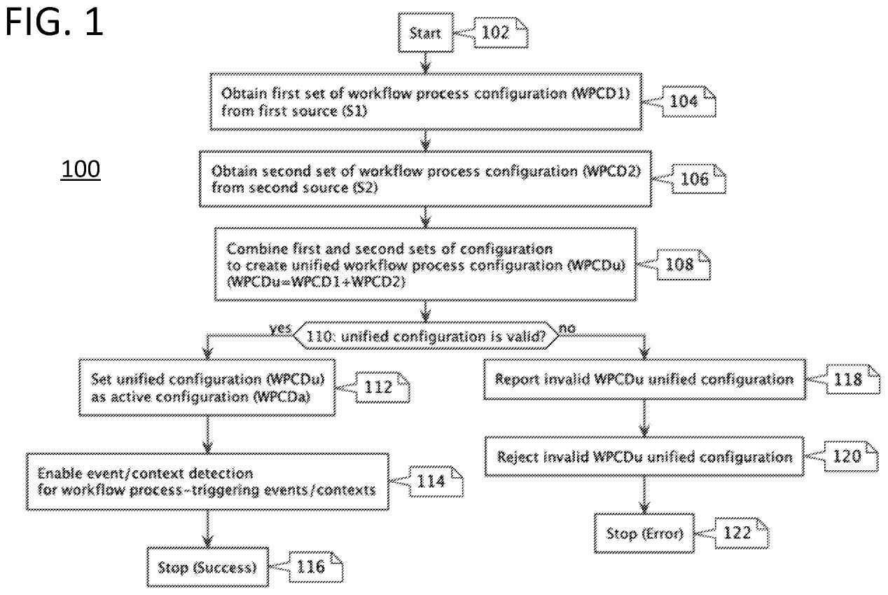

a) obtain one or more sets of workflow process configuration data (WPCD) (see FIGS. 1 & 2), through a graphical user interface, a command line interface, or via other means.

WPCD can be or include, for example, a set of workflow process configuration data which specifies tasks, task dependencies, task instructions, execution options, and similar data required in order to correctly configure and execute each corresponding workflow process. Such workflow process configuration data could specify, for example, any one or more of: a set of task dependency data that specifies the dependencies, inputs, outputs, execution sequence instructions, and permissible optimizations for the set of workflow process tasks configured within a workflow process; a build task that specifies the commands that should be executed to compile a set of software source code to produce a software artifact; a set of configuration data that specifies the settings that should be used to configure a software artifact for a particular configuration mode when deploying or releasing or installing it to a computing environment; a test task that specifies the commands that should be executed to run a set of tests against an instance of a software artifact deployed in a computing environment; and an analysis task that specifies the commands that should be executed to run a set of source code analysis operations targeting a set of software source code. WPCD data can be formatted using one or more file formats or data formats, which may include and/or combine: JSON, XML, YAML, and/or other text or binary formats. WPCD data can be stored in one or more locations, which may include and/or combine: computer memory, a database, a file, a set of files, an SCM repository, and/or various “over-the-wire” transmission formats.

The system can further be configured to:

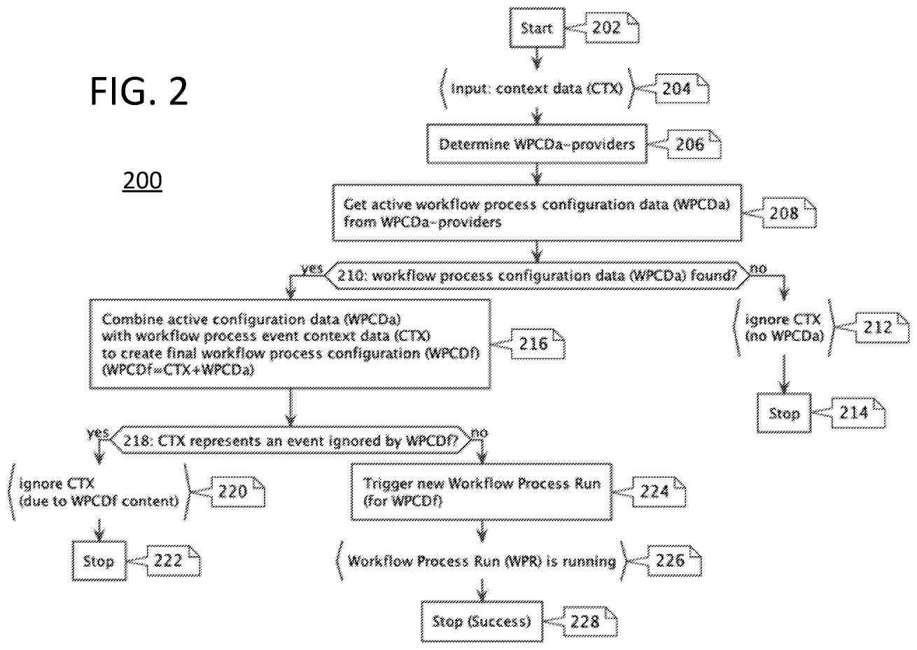

b) combine and/or integrate sets of WPCD from various sources into a set of unified workflow process configuration data (WPCDu) (see FIG. 2).

WPCDu can be or include, for example, any set of WCPD data that is produced as a result of: combining two or more sets of WPCD data (including WPCDu, WPCDa and/or WPCDf data) with each other and/or combining one or more sets of WPCD data (including WPCDu, WPCDa and/or WPCDf data) with other (non-WPCD) data, such as one or more of: event context data (CTX), user authorization data, or data stored in a database, SCM repository, sensitive data repository, artifact repository, and other data storage mechanisms. Examples of WPCDu can include WPCD data resulting from any one or more of: integrating inherited WPCD data, such as organizational default settings, with non-inherited WPCD data, such as WPCD data corresponding with a particular SCM repository; integrating the WPCDf data from a previous workflow process run, with WPCD data corresponding to a subsequent workflow-triggering event context CTX; and integrating two or more sets of WPCD data retrieved from separate locations, such as files located in multiple SCM repositories and/or multiple directories.

The system can further be configured to:

c) promote individual sets WPCDu to be used as a set of active workflow process configuration data (WPCDa) sets (see FIG. 1, step 112) that may be of subsequent use by and/or with other portions of the methods, systems, and embodiments described herein.

WPCDa can be or include, for example, any set of WCPD data (see above), which can be determined (either intrinsically or by the evaluation of additional, separate data) to be enabled and/or activated, and which should be considered “ready to use” in driving a computing system's behavior.

The system can further be configured to:

d) interact with various external systems and/or data as might relate to workflow processes and their configuration, execution, and/or consequent effects, activities, artifacts, and by-products. Examples of such external systems and data include: SCM systems and repositories (see steps 112, 114, 208); issue tracking and/or reporting systems (see step 118); cloud infrastructure providers and/or cloud management platforms (see steps 206, 208, 224); and/or various other systems and/or data as might be relevant for particular workflow processes' configurations and runs.

The system can further be configured to:

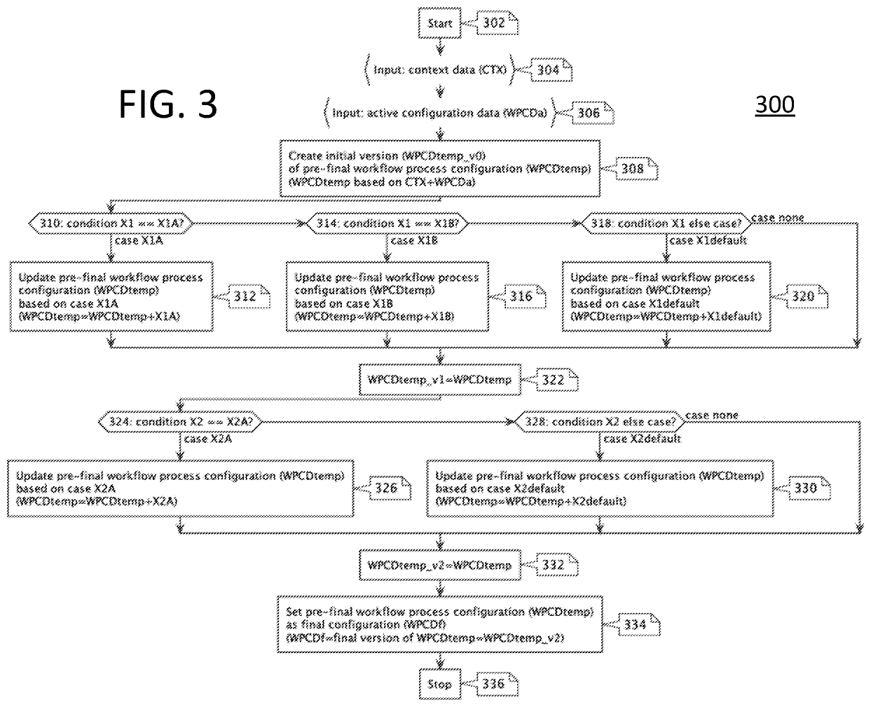

e) perform automated configuration of a set of final workflow process configuration data (WPCDf) (see step 216 & FIG. 3) based upon particular sets of context data (CTX) for an event that triggers a workflow process and corresponding sets of active workflow process configuration data (WPCDa), such that the WPCDf is usable to perform and/or affect the runtime execution of a workflow process run (WPR) or plural WPRs.

WPCDf can be or include, for example, a set of context-optimized workflow process configuration data that has been derived from (and potentially modified to differ from) some pre-optimized (or differently-optimized) workflow process configuration data WPCD (including WPCDu, WPCDa, or another WPCDf). WPCDf can be modified to differ from the WPCD it is derived from in ways which can include, for example, one or more of: excluding a specific task, such as software deployment to a production environment, as a result of evaluating the name of the SCM branch name associated with the triggering event CTX; modifying the configuration data for a specific task, such as a database password used during a software deployment to a production environment, as a result of evaluating the content of source code files related to the SCM branch associated with the triggering event CTX, and a corresponding sensitive data repository; scheduling two independent testing tasks to execute in parallel within separate computing environments, as a result of determining that corresponding computing resources currently have unused capacity; and scheduling two independent testing tasks to execute sequentially within a single computing environment, as a result of determining that corresponding computing resources currently have limited capacity.

CTX can be or include, for example, any set of context data that represents and describes an event that triggers a workflow process. CTX data can contain properties or fields that include, for example, one or more of: an “event type” which can distinguish different kinds or categories of events from each other; an event time; an event source or sources, such as the identity and/or location of the computing system and/or user(s) that caused or detected the event; and additional properties, including event-type-specific properties, representing details about the event. Examples of events that can produce a set of CTX data include, for example: a SCM push to a git SCM repository, where CTX data could include (directly and/or indirectly) the event type, the SCM repository, SCM branch name, git commit SHA, event time, an event identifier; a user clicking a “restart” button in a workflow control computing system, where CTX data could include (directly and/or indirectly) the event type, the user's identity, event time, an event identifier; and a computing system detecting that a workflow-related SCM branch no longer exists, where CTX data could include (directly and/or indirectly) the event type, the SCM repository, SCM branch name, event time, an event identifier.

A WPR can be or include, for example, one or more computing system processes representing a single occurrence or instance of a set of tasks and/or other work performed (and/or to be performed and/or in progress) as specified by a corresponding set of workflow process configuration data (WPCD and/or it's variant sub-types: WPCDf, etc.). A WPR can be formatted in one or more file formats or transmission formats, which can include JSON, XML, YAML, or other text or binary formats. A WPR can be stored in one or more files, databases, or other storage mechanisms. A WPR can be associated with one or more of the following: one or more computing environments, such as computing systems, virtual machines, or container instances, for executing automated tasks; one or more scripts or programs commands used while executing automated tasks; and one or more operating system processes.

Examples of times and scenarios where the system can process CTX data can include: times and occasions which are coincident with the detection and/or availability of CTX data corresponding to a real-world triggering event, such as an SCM source code commit, push, or pull. Methods of detection of such events can include, for example: receipt of an externally-produced request or message (e.g. an interrupt- or push-based CTX) and/or system-internal operations (e.g. a query- or polling-based CTX).

Particular sets of WPCDf data and their corresponding WPRs may or may not vary from each other based upon differences between the WPCDa and CTX data that correspond to a particular WPCDf pair (a WPCDf pair can be a pair of a particular CTX and a WPCDa as discussed below with reference to FIG. 2). For example, the magnitude and/or kinds of differences can be influenced by the magnitude and/or kinds of differences/similarity between the applicable WPCDa and CTX data, possibly including indirect differences in other data and/or systems. For example, given a single WPCDa but two different sets of context data (CTX1 and CTX2), the produced WPCDf data (typically two WPCDf, but possibly more or fewer, depending on a variety of factors and circumstances) could vary in ways corresponding to variances between CTX1 and CTX2, but be similar in other ways as would correspond to the influence of their single, shared WPCDa. Any WPRs corresponding to the aforementioned WPCDf instances could differ from each other in ways and degrees that correspond to the differences and similarities between the WPRs associated WPCDf data.

Consider, for example, two separate commits/pushes to the same SCM repository that are identical in all ways except for the SCM branch affected (e.g. same files modified, commit time, and committer). Commit SCM1 affects a “feature branch” while commit SCM2 targets the “master” branch. Each commit event results in a corresponding event context (e.g. CTX1 and CTX2). If both branches are associated with identical WPCDa data, then the WPCDf instances corresponding to each context (and their corresponding WPR instances) will differ only to the extent that they should differ as a result of the single difference between them (different branches are targeted, as determined from CTX1 and CTX2, but they share an identical WPCDa). In this specific scenario, it would be common that the WPCDf and WPR for the SCM2 to the “master” branch would involve more or different workflow process “segments” than commit SCM1 against a non-master branch.

Workflow process segments that are designated to be executed only during WPRs related to a “commit to master” (such as a “PROD” and/or “UAT” segment) can be omitted from the non-master WPR(s) but included and executed during the “master”-related WPR(s). CTX-optimized WPRs can provide many potential benefits that are infeasible or impossible with non-CTX-optimized WPRs. For example, the benefits of the omission of CTX-irrelevant workflow process segments has many potential benefits that could include (among others): simplified human comprehension, debugging, etc. of the “CTX-optimized” WPRs; shorter/better feedback cycle time of “CTX-optimized” WPRs; lower runtime costs and/or risks related to the execution of “CTX-optimized” WPRs (e.g. by avoiding the costs related to any cloud virtual machines dedicated to the omitted segments).

As another specific example, consider the same scenario as described above, except that each of the two SCM branches is now associated with a different WPCDa instead of being associated with the same WPCDa, as described in the previous example. In this revised scenario, the WPCDf instances (and any corresponding WPR instances) will now differ in ways and extents that reflect two underlying differences (i.e. different branches targeted, as determined from CTX1 and CTX2, and also different WPCDa instances: WPCDa1 for CTX1 and WPCDa2 for CTX2), rather than a single underlying difference. In this particular scenario, the SCM2 commit might result in no WPCDf and no WPR at all. Alternately, SCM2 might still result in a WPR, but one that is based on a completely different segment model and/or cloud infrastructure and/or other WPCDa-related factors based on the degree and kinds of differences between WPCDa1 and WPCDa2.

The system can further be configured to:

f) initiate and manage the execution of particular WPRs corresponding to particular WPCDf(s), such as those mentioned above and elsewhere herein;

The system can further be configured to:

g) perform various additional workflow process-related activities as might be relevant for and/or pertain to other methods, systems, and embodiments described herein.

FIG. 1 illustrates a computer system implemented method 100 that can combine two or more sets of workflow process configuration data (WPCD1, WPCD2, . . . ) into a corresponding set of unified workflow process configuration data (WPCDu) and a set of active workflow process configuration data (WPCDa). The method can also perform processing to validate the WPCDu and enable it as WPCDa. The method can also enable any corresponding event detection. The method 100 starts at a step 102.

At a step 104, a first set of workflow process configuration data (WPCD1) is obtained from a first source (S1) or provider of WPCD. S1 can be, for example, an SCM repository, a user interface enabling a user to provide user-provided WPCD to the system, or a variety of sources. The WPCD provided by these sources can include already active WPCD (see step 112) and/or inactive WPCD, such as new WPCD that has not yet been enabled as active WPCDa. The system can retrieve, receive or access the WPCD1.

WPCD1 can include, for example, a particular workflow process segment model that represents a set of segments (e.g. Build, Functional Test FT, Performance Test PERF, User Acceptance Test UAT, and Production PROD), and various data for each segment (e.g. pertaining to particular dependencies, parallel and/or synchronous execution instructions, inputs, outputs, etc.). WPCD1 can also include other data pertaining to rules, conditions, properties, and/or various other data as may be necessary to define, specify, influence and/or enable correct runtime execution and behavior of a WPR derived from the particular WPCD.

At a step 106, a second set of workflow process configuration data (WPCD2) is obtained from a second source (S2) or provider of WPCD. See step 104 for more information about WPCD2 and S2. S1 and S2 may represent either the same source or two different sources. WPCD1 and WPCD2 may be identical, somewhat similar, or highly dissimilar, irrespective of the particular value of S1 and S2.

At a step 108, the system combines WPCD1 and WPCD2 to produce a unified workflow process configuration data (WPCDu), derived from the WPCD inputs. Although the method 100 includes two WPCD inputs (WPCD1 and WPCD2), there may be 3 or more WPCD inputs, and the method would be modified accordingly.

At a step 110, the system evaluates the validity of the WPCDu to determine whether the unified data is valid for particular uses or purposes. If the WPCDu is determined to be valid, then the process flow proceeds to step 112, else the flow proceeds to step 118.

At a step 112, the WPCDu is processed by the system to convert it into active workflow process configuration data (WPCDa) that is suitable for particular uses and purposes. This may involve storing the WPCDa in a particular WPCDa-provider source (see steps 104, 208), so that it will be available to be obtained during other steps (see steps 104-106, 206-208). The WPCDa can be used immediately (without storage) for particular purposes.

At a step 114, the system can perform various activities as necessary to enable subsequent detection by relevant systems of events that need to be detected in order to correctly and appropriately trigger the execution of WPRs. This step may involve using the particular WPCDa to determine or infer particular events and event sources that require monitoring. It can also involve the use of particular WPCDa (e.g. URLs, IP addresses, etc.) as inputs to the processes which interact with particular event sources to enable event detection. For example, at the step 114, the system can infer from particular WPCDa that a git hook needs to be enabled for a particular git SCM repository and obtain the particular git repository information from the WPCDa that is needed to enable the system to automatically configure and enable such a git hook. Different WPCDa data and/or different event source systems and/or different enablement processes may be involved. As another example, at the step 114, event detection can involve the activation of monitoring, polling, and/or various other forms of detection, such as push-based, pull-based, interrupt-based, request-based, and/or other means of detection.

At a step 116, the depicted process flow terminates successfully.

At a step 118, in the case the WPCDu is determined to not be valid, the detection of an invalid WPCDu is reported. The reporting can involve logging information to a file, database, and/or other log stream. The reporting can involve reporting information to a user via a user interface (e.g. a GUI or a CLI) and/or messaging channel (e.g. using email, a chat channel, an IM message, an SMS text message, and/or other means).

At a step 120, the invalid WPCDu is rejected without enabling it as an active WPCDa.

At a step 122, the depicted process flow terminates unsuccessfully.

FIG. 2 illustrates a computer system implemented method 200 for dynamically identifying any active workflow process configuration data (WPCDa) associated with a particular set of context data (CTX), and for dynamically configuring, using context-optimized configuration, CTX-specific final workflow process configuration data (WPCDf) that can then be used to trigger and execute a new workflow process run (WPR). The method can provide context-optimized configuration and subsequent execution of a workflow process run of a final workflow process configuration (WPCDf) based on: a set of context data (CTX) and access to a corresponding active workflow process configuration (WPCDa).

In one embodiment, workflow process-enabled CTX can trigger workflow process runs whereas, non-workflow process-enabled CTX will not trigger any workflow process runs. Any CTX that is determined to have no active workflow process configuration data (WPCDa) associated with it, can be considered to be “not workflow process-enabled”. Consequently, associating active workflow process configuration data (WPCDa) with a given set of events/contexts can be considered “enabling workflow processes” for the given set of contexts. Contexts that are already workflow process-enabled can still be workflow process-enabled by associating additional WPCDa to the already-enabled contexts, potentially-resulting in multi-workflow process-enabled contexts. It may be possible for particular kinds of events/contexts to be conditionally-workflow process-enabled and therefore implicitly conditionally-workflow process-disabled as well by workflow process-enabling contexts using WPCDa that contains certain kinds of rules that prevent the triggering of WPRs for some CTX but not other CTX.

The method 200 starts at a step 202. At a step 204, the system receives or accesses a particular set of context data (CTX) as input.

A particular CTX can correspond to an event representing a particular commit or push (Commit1) to a particular git SCM repository. For example, the CTX can include particular data directly pertaining to the particular commit, including relevant unique identifiers (e.g. IDs for the commit and the git SCM repository) and possibly including other details or information, such as the target branch, committer, commit message, etc. Such CTX data content may be subsequently used throughout the process flow to effect CTX-specific, CTX-optimized behavior.

At a step 206, the system determines or identifies appropriate sources/providers of WPCDa data. The determination may be CTX-dependent or independent of the particular CTX. A particular CTX can correspond to a git SCM commit or push (Commit1) as described in the previous example relating to step 204. In this example, the system can consider the particular files/content of Commit1 (i.e. the complete and exact file hierarchy that is associated with Commit1, and accessible from the SCM repository using the commit ID) to be an appropriate potential source of WPCDa data, since particular WPCDa data may be stored as a version-controlled file in the repository. Furthermore, since Commit1 defines a particular, versioned state of the SCM repository, the commit's files/content would be a CTX-specific source of WPCDa data, given that different CTX (corresponding to a different commit) may (or may not) correspond to a different file hierarchy and therefore potentially containing different WPCDa.

At a step 208, the system retrieves any available active workflow process configuration data (WPCDa) that pertain to the current CTX from the previously-identified WPCDa-providers. There will typically be zero or one WPCDa per CTX. There may, however, be two or more WPCDa configurations (not explicitly depicted in FIG. 2 for clarity). Continuing with the ongoing example, since the particular CTX identifies a particular commit (Commit1) corresponding to a particular state of a particular file hierarchy (Files1) in a particular SCM repository (SCM1), the system may (as part of step 208) attempt to access Files1 (using the data in CTX) in order to determine whether Files1 contains WPCDa data relevant to the particular CTX (WPCDa1). If Files1 is determined to contain WPCDa1, then WPCDa1 would be retrieved from Files1 (if possible) for subsequent use.

At a step 210, the process flow forks conditional upon whether CTX is determined to be workflow process-enabled or not. If valid WPCDa is successfully retrieved for the CTX from any of the identified WPCDa-providers (see step 206), then the CTX is workflow process-enabled and the process flow proceeds to step 216, else the CTX is not workflow process-enabled and the flow proceeds to step 212. Continuing with the ongoing example, if some WPCDa1 was successfully retrieved from Files1 (see step 208), then the CTX is workflow process-enabled and the process flow proceeds to step 216, else the CTX is not workflow process-enabled and the flow proceeds to step 212.

At a step 212, the workflow process-triggering the CTX that was an input at step 204 will be ignored and will not result in a new workflow process run WPR as a consequence of the system finding no active WPCDa data that corresponds to the particular CTX input. Continuing with the ongoing example, if no WPCDa1 was successfully retrieved either from Files1 or from any other WPCDa-providers, then the CTX represents an event for which there is no active workflow process configuration data (WPCDa).

At a step 214, the method terminates without triggering any WPRs.

At a step 216, upon determining that valid WPCDa is retrieved, the system combines the particular CTX and any associated WPCDa to produce a CTX-optimized final workflow process configuration data (WPCDf). The process flow represented by this step is shown in more detail in FIG. 3, which would typically occur once per (CTX, WPCDa) pair.

Typically, the system would generate exactly one WPCDf per (CTX, WPCDa) pair regardless of the number of WPCDa identified for a particular CTX. Consider the following four examples of different numbers of CTX and WPCDa generating different numbers of WPCDf:

a. 1 CTX & 1 WPCDa=1 pair=1 WPCDf: (CTX1, WPCDa1)

b. 3 CTX & 2 WPCDa=6 pairs=6 WPCDf: (CTX1, WPCDa1), (CTX1, WPCDa2), (CTX2, WPCDa1), (CTX2, WPCDa2), (CTX3, WPCDa1), (CTX3, WPCDa2)

c. 1+CTX & 0 WPCDa=0 pair=0 WPCDf: (0 WPCDa implies “not workflow process-enabled”)

d. 0 CTX & 1+WPCDa=0 pair=0 WPCDf: (0 CTX implies “no workflow process-triggering events”)

At a step 218, the process flow forks conditional upon whether CTX is determined (per the particular WPCDf data) to be an “ignorable” context/event or not. If the combination of a particular CTX and WPCDf indicates that the given CTX should be ignored (i.e. CTX should not trigger a WPR), then CTX is considered to be conditionally-workflow process-disabled and the process flow proceeds to step 220, else CTX is workflow process-enabled and the flow proceeds to step 224.

At a step 220, the workflow process-triggering context (CTX) that was an input for the process flow depicted in FIG. 2 (see step 204) can be ignored (i.e. it will not result in a new workflow process run WPR) as a consequence of the particular content of the WPCDf data (see step 216) that corresponds to the particular CTX.

At a step 222, the method terminates without triggering any WPRs.

At a step 224, in the case that the CTX does not represent an ignorable event, a new workflow process run (WPR) is triggered. This new WPR directly corresponds to the particular CTX, WPCDa, and WPCDf that were obtained earlier during this process flow. At a step 226, the newly-triggered WPR (see step 224) executes and enters a running/active state.

At a step 228, the method terminates successfully, having triggered a new WPR.

FIG. 3 illustrates an example computer system implemented method 300 that can combine workflow process run context (CTX) and active workflow process configuration data (WPCDa) to produce a CTX-optimized final workflow process configuration data (WPCDf). The method 300 represents one example of a method that could be used during the execution of the internal processes represented step 216 of the method 200 (FIG. 2). The method can provide the context-optimized configuration of a final workflow process configuration (WPCDf) based on a set of context data (CTX) and a set of active workflow process configuration data (WPCDa). The method 300 starts at a step 302.

In the example method 300 described below, each of two conditions are evaluated, with the first condition having three possible scenarios and the second condition having two possible scenarios, and with the evaluation and processing of each condition leading to an updated pre-final workflow process configuration. In other example methods, more or fewer conditions can be evaluated, with each condition being evaluated having any number of possible scenarios, and any number of iterations of a pre-final workflow process configuration can be created before reaching a final workflow process configuration.

At a step 304, the system receives or accesses a set of context data (CTX). At a step 306, the system receives or accesses a set of active workflow process configuration data (WPCDa).

At a step 308, the system combines the CTX and the WPCDa to produce an initial “baseline” pre-final workflow process configuration (WPCDtemp). The initial version (v0) of WPCDtemp can be designated as WPCDtemp_v0.

At steps 310, 314, and 318, the example process flow forks conditional upon the CTX-specific evaluation of a particular condition or criteria (X1) featuring (as depicted) 3 possible process flow paths corresponding to 3 distinct outcomes (X1A, X1B, and X1default) of the evaluation of X1. If X1 evaluates to case X1A, then the process flow proceeds to step 312. If X1 evaluates to case X1B, then the process flow proceeds to step 316. If X1 evaluates to case X1default, then the process flow proceeds to step 320. If none of the X1 conditions is satisfied (see steps 310, 314, 318), then the process flow proceeds to step 322. Therefore, steps 312, 316, and 320 correspond to the specific methods the system would use in applying appropriate modifications to WPCDtemp for cases X1A, X1B, and X1default (respectively).

In various instances of steps 310, 314, and 318, each of the depicted outcomes of X1 evaluation (X1A, X1B, and X1default) may be mutually exclusive, such that exactly one of the cases may be traversed during a particular process flow. Whereas, in other instances, X1A, X1B, and X1default may be mutually compatible, such that two or more of the corresponding flow paths (see steps 312, 316, 320) could be traversed (either sequentially and/or in parallel, depending on the particular embodiment and example in question). In some instances of steps 310, 314, and 318, it may be possible for none of the depicted outcomes of X1 evaluation (X1A, X1B, and X1default) to be satisfied, such that exactly zero of the X1-specific steps (see steps 312, 316, 320) may be traversed during a particular process flow. Whereas, in other instances, it may be that at least one of those outcomes/steps (X1A, X1B, and X1default) will always occur, such that the one or more corresponding flow paths (see steps 312, 316, 320) would always be traversed.

In one example, the context CTX may represent a particular commit or push (Commit1) to a particular branch (Commit1branch) in a particular git SCM repository (SCM1) and the condition X1 may represent the determination of which workflow process segments should be included in a workflow process run WPR corresponding to the particular CTX, and WPCDa can be assumed to be identical across all variations of this particular example. In such an example, if Commit1branch equals “master” (case X1A), then all segments described by the segment model in WPCDa would be included in WPCDtemp (and hence included in the corresponding WPR). However, if Commit1branch starts with a certain prefix or prefixes (e.g. “skip_” and/or “old_”) (case X1B), then WPCDtemp may be updated such that no WPR will be triggered as a result of CTX. Otherwise (case X1default), some (but possibly not all) segments described by the segment model in WPCDa would be included in WPCDtemp (and hence included in the corresponding WPR). For example, in case X1default, certain segment (e.g. UAT, PROD) may be excluded from WPCDtemp, such that those segments would be effectively omitted/excluded except when X1 evaluates to case X1A. Note that while a similar end result (to the WPRs) could be achieved by using different a WPCDa for each branch, where each branch contained a file defining a PDCa with only the segments applicable to it, such a solution would be substantially inferior in terms of the non-WPR-related impact on developers. For example, every merge from a branch into master would have a chance of unintentionally overwriting and/or cluttering the master branch with the WPCDa files/versions from the non-master branches. Also, the need to separately maintain multiple PDCa versions would entail additional risks and costs versus maintaining a single WPCDa (shared by all branches), that can be dynamically converted (via CTX-optimized configuration) as needed into a CTX-appropriate WPCDf. Furthermore, it should be noted that the use of CTX-optimized configuration and a WPCDa shared across many branches does not preclude or prevent individual branches from using a separate (i.e. non-shared) WPCDa, if and when appropriate.

At a step 322, the content of WPCDtemp, after modifications have been applied during the prior steps (see steps 310-320) as pertains to the updates corresponding to the CTX-specific evaluation of “condition X1”, form a new interim version (v1) of WPCDtemp, designated as WPCDtemp_v1.

At steps 324 and 328, the example process flow forks conditional upon the CTX-specific evaluation of a particular condition or criteria (X2) featuring (as depicted) two possible process flow paths corresponding to two distinct outcomes (X2A and X2default) of the evaluation of X2. If X2 evaluates to case X2A, then the process flow proceeds to step 326. If X2 evaluates to case X2default, then the process flow proceeds to step 330. If none of the X2 conditions is satisfied (see steps 324, 328), then the process flow proceeds to step 332. Therefore, steps 326 and 330 correspond to the specific methods the system would use in applying appropriate modifications to WPCDtemp for cases X2A and X2default (respectively).

Note that steps 310 through 322 (see steps 310-322) are substantially similar (and vice versa) to steps 324 through 332 (see steps 324-332), except that the former depict a set of process flow forks related to the possible cases of a condition X1 (with 3 possible evaluation outcomes depicted), whereas the latter depict the same thing but for a condition X2 (with only two depicted outcomes instead of 3). For the sake of clarity, some of the examples and notes corresponding to the former (X1) set of steps (see steps 310-322) were not explicitly repeated herein for the latter set of steps (nor for any of the other sets of conditional steps that were not explicitly depicted, as described below). However, all such omitted examples and notes are to be considered to be applicable (with appropriate modifications as needed to accommodate the differences between sets) to all such sets of steps, and to be intentionally included within and covered by the scope of the present invention described herein, despite omission.

Note that for the sake of clarity, only two sets of condition-specific forks are depicted in this figure, corresponding to two specifically-depicted conditions X1 (see steps 310-320) and X2 (see steps 324-330). However, it should be noted that for specific examples and particular embodiments, the number, type, methods of evaluation, effects, etc. of the conditions/criteria may differ substantially from the two (simplified for clarity) forks depicted (e.g. X1 through X999). Similarly, the number, effects, methods, mutual exclusivity, etc. of the evaluation paths/cases for any particular condition may similarly vary (e.g. cases X3A through X3ZZZ or X99A through X99D). Also, the evaluation of each individual condition (e.g. X1) may internally involve multiple methods and/or steps (e.g. the evaluation of complex, multi-dimensional criteria for a single condition, such as X1). The entire variety of such complexities is to be considered to be intentionally included within and covered by the scope of the present invention described herein, despite the omission (from the simplified method 300 in FIG. 3) of the majority of the possible variants of such complexities.

At a step 332, the content of WPCDtemp, after modifications have been applied during the prior steps (see steps 324-330) as pertains to the updates corresponding to the CTX-specific evaluation of “condition X2”, form a new interim version (v2) of WPCDtemp, designated as WPCDtemp_v2.

At a step 334, after all CTX-specific modifications as may be appropriate have been applied to the content of WPCDtemp, the final version of WPCDtemp is designated as the final workflow process configuration data (WPCDf) and can be returned as an output of the method 300.

At a step 336, the method 300 terminates successfully.

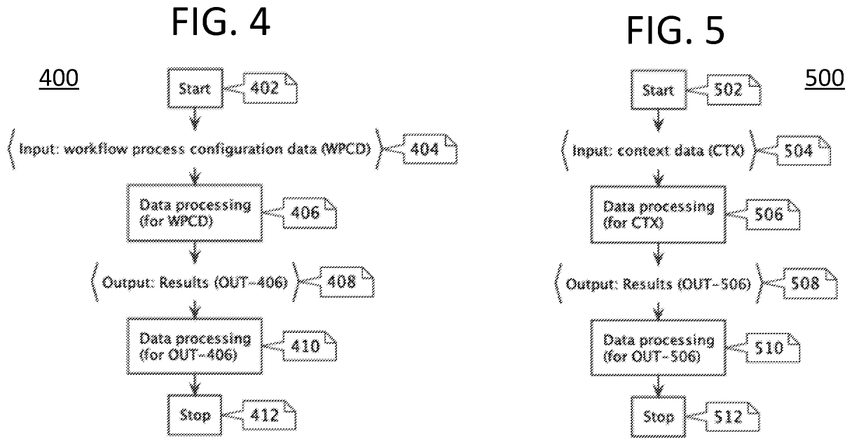

FIG. 4 illustrates a computer system implemented method 400 for performing data processing operations on, to, and/or with an input set of workflow process configuration data (WPCD) and for producing a set of output(s) pertaining to such data processing. Other inputs can be accepted in addition to and/or instead of the input WPCD. Any such other inputs may also affect and/or influence any of the other steps and/or outputs of the method 400. Such other inputs may be of similar and/or dissimilar types, content, origins, etc. relative to WPCD. The method 400 starts at a step 402.

At a step 404, the system receivers or accesses a set of workflow process configuration data (WPCD) as input. The WPCD may be subsequently used throughout the process flow to effect WPCD-specific behavior and/or operations and/or output(s). The set of workflow process configuration data can include one or more of: active configuration data (WPCDa); final configuration data (WPCDf); unified configuration data (WPCDu); any other kind of configuration data (WPCD); and a derived and/or transformed and/or converted version of one or more other sets of configuration data. The set of configuration data can be: valid configuration data; and/or invalid configuration data.

At a step 406, the system can perform one or more data processing operations upon and/or using and/or to the WPCD input. Any information resulting from and/or pertaining to any such operations may also be used as part of the output of the process flow 400. For example, a particular WPCD could correspond to an invalid WPCDu, the system would detect that the WPCD was invalid, and would automatically repair and/or remediate the input WPCD, resulting in a valid WPCD-fixed that is derived from the invalid WPCD input. For the particular embodiment just described, WPCD-fixed would then be used as part of the output of the process flow 400. Several other specific examples of step 406 of various particular embodiments applying embodiment-appropriate operations to a WPCD are depicted throughout the figures herein (see step 108, 112, 114, 118, 120, 208, 216, 218, 224, 310-332, 334, and FIGS. 2, 3).

At a step 408, the method 400 may generate a set of outputs (OUT-406), representing data and/or information pertaining to the execution of each particular process flow. The outputs may include one or more of: any kind of configuration data (WPCD, WPCDu, WPCDa, WPCDf, etc.); any kind of context data (CTX); a derived and/or transformed and/or converted version of one or more of the process flow's inputs and/or outputs; and any other data and/or information.

At a step 412, the depicted process flow terminates.

FIG. 5 illustrates a computer system implemented method 500 for performing data processing operations on, to, and/or with some set of context data (CTX) input and of producing a set of output(s) pertaining to such data processing. Other inputs may be accepted in addition to and/or instead of the input CTX. Any such other inputs may also affect and/or influence any of the other steps and/or outputs of the method 500. Such other inputs may be of similar and/or dissimilar types, content, origins, etc. relative to CTX. The method 500 starts at a step 502.

At a step 504, the system receivers or accesses a set of context data (CTX). The CTX content may be subsequently used throughout the process flow to effect CTX-specific, CTX-optimized behavior and/or operations and/or output(s). For example, a set of CTX could correspond to an event representing a particular commit or push (Commit1) to a particular git SCM repository. The CTX data would include particular data directly pertaining to the particular commit, including relevant unique identifiers (e.g. IDs for the commit and the git SCM repository) and possibly including other details or information, such as the target branch, committer, commit message, etc. The specific example just described is depicted for some particular embodiments in the context of step 206 of the method 200. The same example just described also applies (though for different particular embodiments) to various other steps (see steps 208, 216, 308, 310-332, 334).

At a step 506, the system performs one or more data processing operations upon and/or using and/or to the CTX input. Any information resulting from and/or pertaining to any such operations may also be used as part of the output of the process flow 500. For example, a particular CTX could correspond to a git SCM commit or push (Commit1) as described in the previous example relating to step 504. Several examples of various particular embodiments applying embodiment-appropriate operations to such a CTX are depicted throughout the figures herein (see steps 206, 208, 216, 308, 310-334, and FIGS. 2, 3).

At a step 508, the method 500 may generate a set of outputs (OUT-506), representing data and/or information pertaining to the execution (see step 506, and FIG. 5) of each particular process flow. The outputs may include one or more of: any kind of configuration data (WPCD, WPCDu, WPCDa, WPCDf, etc.); any kind of context data (CTX); a derived and/or transformed and/or converted version of 1 or more of the process flow's inputs and/or outputs; and any other data and/or information.

At a step 512, the depicted process flow terminates.

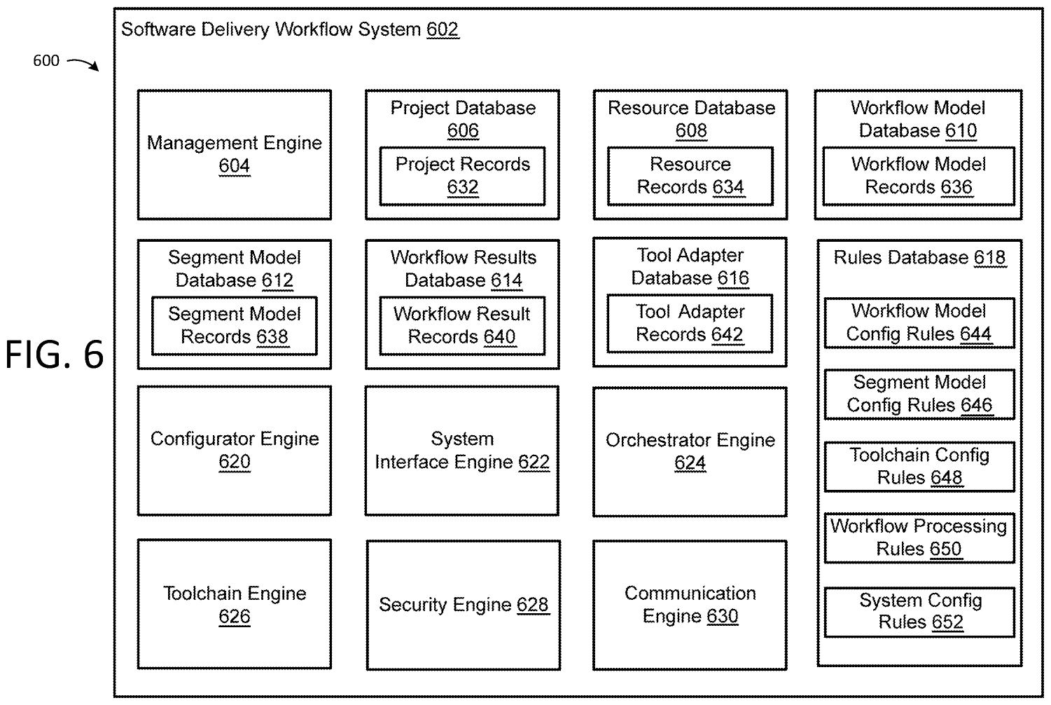

FIG. 6 depicts a block diagram 600 of an example of a automated configuration and execution of context-optimized software development workflow processes system 602 (software development workflow processes system). Generally, the software development workflow process system 602 functions to integrate, build, test, and deploy projects and/or applications in a repeatable, reliable manner. In some embodiments, particular workflow processes may be executed in a fully automated manner (i.e. with direct no human involvement) and/or other workflow processes may be executed in a partially automated (and partially non-automated) manner.

The system 600 can include (physically and/or logically) subsystems and/or elements that can include: a set of engines (604, 620-630); a set of databases (606-618); and various sets of data (632-642, 644-652) (e.g. engine and system configurations, database records (632-642), sets of rules (644-652)) corresponding to the system's various engines, databases, etc. described herein.

The engines (604, 620-630) can include: a management engine 604, a configurator engine 620, a system interface engine 622, an orchestrator engine 624, a toolchain engine 626, a security engine 628, and a communication engine 630. In a particular embodiment, each such engine comprises a library of executable instructions which are executable by a processor for performing any of the respective engine's operations and/or functionality as described herein (and/or implied).

The databases (606-618) can include: a project database 606, a resource database 608, a workflow process model database 610, a workflow process segment model database 612, a workflow process results database 614, a tool adapter database 616, a rules database 618. The databases 606-618 may be any structure and/or structures suitable for storing the records 632-642 and/or the rules 644-652 (e.g., an active database, a relational database, a table, a matrix, an array, a flat file, and the like).

The data sets (632-642, 644-652) can include: project records 632, resource records 634, workflow process model records 636, workflow process segment model records 638, workflow process results records 640, tool adapter records 642 and configuration rules data (see #644-652).

The configuration rules data (644-652) can include: workflow process model configuration rules 644, segment model configuration rules 646, toolchain configuration rules 648, workflow process processing configuration rules 650, and system configuration rules 652.

The management engine 604 can be used to manage, maintain, and/or administer the system's various data sets (e.g. database records, rules data, engine configuration data, etc.). Such operations more specifically (but non-exhaustively) may include database records management (e.g., create, read, update, delete, or otherwise access) operations that may involve: project records 632 stored in the project database 606, resource records 634 stored in the resource database 608, workflow process model records 636 stored in the workflow process model database 610, workflow process segment model records 638 stored in the workflow process segment model database 612, workflow process result records 640 stored in the workflow process results database 614, tool adapter records 642 stored in the tool adapter database 616, and rules 644-652 stored in the rules database 618. The management engine 604 may initiate and/or perform such operations on-demand (e.g. manually, by an administrator interacting with a GUI) and/or automatically (e.g. at the request of one or more of the engines 620-630).

The project database 606 can be used to retain, access and/or manage the project records 632 data. The resource database 608 can be used to retain, access and/or manage the resource records 634 data. The workflow process model database 610 can be used to retain, access and/or manage the workflow process model records 636 data. The segment model database 612 can be used to retain, access and/or manage the segment model records 638 data. The workflow process results database 614 can be used to retain, access and/or manage the workflow process results records 640 data. The tool adapter database 616 can be used to retain, access and/or manage the tool adapter records 642 data. The rules database 618 can be used to retain, access and/or manage the rules records 644-652 data.

The configurator engine 620 can be used to perform and/or manage the configuration of workflow processes. Such operations more specifically (but non-exhaustively) may include: execution of the workflow process model configuration rules 644, the workflow process segment model configuration rules 646, and/or the toolchain configuration rules 648. Thus, for example, the configurator engine 620 may generate and configure various projects (e.g., the projects stored in the project records 632), resources (e.g., the resources stored in the resource records 634), software development workflow process models (e.g., the models stored in the records 636), and workflow process segment models (e.g., stored in the segment model database 638).

The system interface engine 622 can be used to access and/or manage the system's various interfaces (e.g. GUIs, APIs, etc.). Such operations more specifically (but non-exhaustively) may include: generation and/or presentation of graphical user interfaces GUIs (and/or of other kinds of interfaces, such as APIs, CLIs, etc.) for interacting with the configurator engine 620 and/or other features of the system 602 (e.g., databases 606-616). For example, the system interface engine 622 can generate interfaces for creating and/or adjusting template segment models, new segment models, projects, resources, and software development workflow process models. Similarly, in some embodiments, the system interface engine 622 can generate displays for presenting workflow process execution results and/or segment model execution results.

The orchestrator engine 624 can be used to perform and/or manage the execution of workflow processes and workflow process runs (WPRs). Such operations more specifically (but non-exhaustively) may include: execution of the software development workflow process model processing rules 650. Thus, for example, the orchestrator engine 624 can detect events and coordinate system-wide responses to events. For example, the response to a particular workflow process-triggering event (CTX) may be to initiate the execution of a workflow process run (WPR) using a particular software development workflow process model (WPCDf). More specifically, the steps involved in such a response may include: determining the events, tasks, and/or actions (collectively, “actions”) to execute, coordinating the executions of such actions, identifying appropriate types, instances, etc. of the (system-internal and/or external) tools, engines, etc. to perform such actions, and the determination and coordination of the system's response to workflow process run WPR execution results (e.g. during a particular WPR determining, based upon partial WPR execution results, whether to advance/proceed/continue, terminate/abort/stop, or suspend/hold/pause the continued execution of the WPR).

The toolchain engine 626 can be used to perform and/or manage interactions, communications, and/or integrations between the system 602 and various external tools, and/or systems. Such operations more specifically (but non-exhaustively) may include: triggering the execution of (potentially tool-specific) operations by one or more tools (internal and/or external to the system 602). For example, each tool can be associated with a tool adapter, and the engine 626 can trigger actions of a particular tool using a corresponding tool adapter. Accordingly, when a software development workflow process model is executed, the engine 626 can interface with other components of the system 602 to trigger actions of the appropriate corresponding tools without the other components requiring tool implementation-specific information. This can also permit, for example, changing of tools without substantially interrupting operation of the system 602, since the other components do not require tool information that is specific to a particular implementation and/or instance of a particular tool. The toolchain engine 626 can utilize tool adapters to trigger the execution of a particular operation by one or more tools' corresponding instances, based upon a triggering event (e.g. a request by another engine) that may not directly provide sufficient tool-related information (e.g. by not providing the address, version, and/or similar details about the corresponding tool) to otherwise enable the direct execution of the aforementioned operation.

The security engine 628 can be used to perform and/or manage functionality pertaining to data security, identity management, and similar operations. Such operations more specifically (but non-exhaustively) may include: authentication, authorization, and/or identity management functionality for requests to and/or from the system's interface engine 622; encryption and/or decryption (and/or similar security-related functionality) of data and/or messages to, from, and/or in the system; enforcement of access control, activity logging and/or similar security measures pertaining to data flowing to, from, and/or through the system. For example, the security engine 628 may compare the configured permissions of an associated project, resource, software development workflow process, etc., with the effective permissions of a particular user before allowing that user to modify, execute, or otherwise access the associated project, resource, software development workflow process, etc. The security engine 628 can also be configured to provide encryption, decryption, or other security measures for the software development workflow process system 602. For example, the security engine 628 can encrypt data messages transmitted from the system 602 and decrypt data messages received at the system 602.

The communication engine 630 can be used to perform and/or manage the transmission and/or exchange of data (e.g. moving data into, out of, and/or inside the system). Such operations more specifically (but non-exhaustively) may include: functions to send data to and/or receive data from one or a plurality of systems, networks, and/or devices. The communication engine 630 may send requests to and/or receive data from a system through a network and/or a portion of a network. Depending upon embodiment-specific or other considerations, the communication engine 630 can send requests and receive data through a connection, all or a portion of which can be a wireless connection.

The communication engine 630 can request and receive messages and/or other communications from other internal and/or external systems, tools, devices, etc.

The project records 632 can each include a variety of attributes and values associated with a project. For example, a project may comprise an online music store platform being developed in accordance with the teachings herein. The project records 632 can store some or all of the following data:

Project Identifier: an identifier (e.g., a key or UID) that identifies the stored project;

Project Name: name of the stored project (e.g., online music store platform);

Properties: properties associated with the stored project (for example, properties may include additional identifiers (e.g. a key or UID or URI) that allow the project to be correlated to data in an external tool or system);

Resource(s): one or more resources associated with the stored project;

Rule(s): one or more rules (e.g., rules 644-652) associated with the stored project;

Tool(s): one or more tools (e.g., SCM, Project Management, Binary Repository, etc.) associated with the project;

Software development workflow process model(s): one or more software development workflow process model(s) associated with the stored project;

Permissions: permissions required to access the stored project (for example, permissions may be based on a user role (e.g., “developer,” “administrator,” etc.), a user-by-user basis, and so forth); and

Timestamp(s): time/date information for associated CRUD operations performed on the stored project record, e.g., Project Online Music Store created on 2016-05-01 @ 1:30 PM.

The resource records 634 may each include a variety of attributes and values associated with a resource of a project or of the system itself. For example, a resource may represent a server, document, device, data (e.g. a document or file), and/or a variety of other kinds of real and/or virtual assets, objects, etc. The resource records 634 can store some or all of the following data:

Resource Identifier: an identifier (e.g., a key or UID) that identifies the stored resource;

Resource Name: name of the stored resource (e.g., XYZ server);

Properties: properties associated with the stored resource (for example, properties may include additional identifiers (e.g. a key or UID or URI) that allow the resource to be correlated to data in an external tool or system;

Rule(s): one or more rules (e.g., rules 644-652) associated with the stored resource;

Tool(s): one or more tools (e.g., SCM, Project Management, Binary Repository, etc.) associated with the project;

Software development workflow process model(s): one or more software development workflow process model(s) associated with the stored resource;

Permissions: permissions required to access the stored resource (for example, permissions may be based on a user role (e.g., “developer,” “administrator,” etc.), a user-by-user basis, and so forth); and

Timestamp(s): time/date information for associated CRUD operations performed on the stored resource record, e.g., “XYZ server created on 2016-05-01 @ 1:35 PM”.

The workflow process model records 636 may each include a variety of attributes and values associated with a software development workflow process model. For example, a software development workflow process model may include a model (e.g., data model and/or function model) for integrating, building, testing, and deploying an application or project. The software development workflow process model can include a node graph (e.g., directed node graph) model. In another particular embodiment, the software development workflow process model comprises a dependency map model. In another particular embodiment, the software development workflow process model comprises a declarative data file and/or manifest. The workflow process model records 636 can store some or all of the following data:

Workflow process model Identifier: an identifier (e.g., a key or UID) that identifies the stored software development workflow process model;

Template or Custom: indicates whether the software development workflow process model is a template model or a custom build model;

Workflow process model Name: name of the stored software development workflow process model;

Resource(s): one or more resources associated with the stored software development workflow process model;

Project(s): one or more projects associated with the stored software development workflow process model;

Workflow process Segment Model(s): one or more workflow process segment model(s) included in the stored software development workflow process model;

Segment Model Dependencies: workflow process segment model dependencies included in the stored software development workflow process model (for example, a second workflow process segment model (e.g., an FT workflow process segment model) can depend on an execution result (e.g., a pass value) of a first workflow process segment model (e.g., a CI workflow process segment model));

Rule(s): one or more rules (e.g., rules 644-652) associated with the stored software development workflow process model;

Permissions: permissions required to access the stored software development workflow process model (for example, permissions can be based on a user role (e.g., “developer,” “administrator,” etc.), a user-by-user basis, and so forth); and

Timestamp(s): Time/date information for associated CRUD operations performed on the stored software development workflow process model. For example, timestamp information can be generated when a CRUD operation is performed, e.g., creating the software development workflow process model, executing the software development workflow process model, etc.

The workflow process segment model records 638 may each include a variety of attributes and values associated with a software development workflow process segment model (or, “workflow process segment model”). For example, a workflow process segment model can comprise a CI segment model, a FT segment model, a UAT segment model, a PT segment model, a SSC segment model, a DSS segment model, an SI segment model, a PROD segment model, and the like. In various embodiments, workflow process segments can be executed in different environments (e.g., an AWS environment or other cloud computing environment). For example, a CI workflow process segment of a software development workflow process model may be executed in a first environment, and an FT workflow process segment of the same software development workflow process model may be executed in a different environment.

The workflow process segment model records 638 can store some or all of the following data:

Segment Model Identifier: an identifier (e.g., a key or UID) that identifies the stored segment model;

Segment Model Type: the type of segment model stored in the segment model record, e.g., CI segment model, a FT segment model, a UAT segment model, a PT segment model, a SSC segment model, a DSS segment model, an SI segment model, a PROD, etc.;

Template or Custom: indicates whether the segment model is a template segment model or a custom build segment model (or, “custom segment model”);

Event(s): event(s) associated with the stored segment model, e.g., a “Start Event” that may be triggered when a workflow process segment model is triggered during execution of a software development workflow process model, an “End Event” that may be triggered upon completed “Start Event” of a workflow process segment model execution, and so forth;

Task(s): tasks (or, “actions”) associated with the stored workflow process segment model and/or event (e.g., Start Event). Tasks may be triggered during an execution of a software development workflow process model including the stored workflow process segment model. For example, an action associated with a CI workflow process segment model type can include cloning a source code repository. When a task is triggered, it may cause associated tool(s) to perform the task(s);

Segment Model Dependencies: identifies dependencies of the stored segment model type. For example, an FT segment model may require input from a CI segment model, or a particular segment model may have defined one or more dependencies between tasks. Accordingly, an alert may be generated if a user attempts to create a software development workflow process model or a segment model that violates one or more dependencies. In a particular embodiment, segment model dependencies can include requirements and/or predetermined data for on-demand execution (e.g., input values, output values, source code, artifacts, binaries, etc.) and/or parallel execution;

Segment Priorities: a priority (e.g., critical, non-critical, high, low, etc.) of the segment model, events of the segment model, and/or tasks of the segment model;

Task Sequence: an execution sequence of the task(s). The task sequence can be based on one or more segment priorities. For example, a particular task sequence may define that only tasks with a particular priority should be executed (e.g., critical); and

Rule(s): rules associated with the stored workflow process segment model, e.g., rules 644-652.

The workflow process result records 640 may each include a variety of attributes and values associated with results of software development workflow process model executions (or, “runs”). The workflow process result records 640 can store some or all of the following data:

Result Identifier: an identifier (e.g., a key or UID) that identifies the stored result record;

Software development workflow process model: the software development workflow process model that generated the result record;

Segment Model: the segment model that generated the result record;

Project: the project associated with the software development workflow process model;

Overall Workflow process Result: an overall result of execution of the software development workflow process model. For example, an overall workflow process result can be a qualitative value (e.g., “Pass” or “Fail”), and/or a quantitative value (e.g., percentage value);

Overall Segment Model Results: overall result of execution for each of the segment models of the software development workflow process model. For example, an overall segment model result can be a qualitative value (e.g., “Pass,” “Fail,” or “Not Executed”), and/or a quantitative value (e.g., percentage of tasks passed);

Event Results: a result of execution for each of the events of the segment models. For example, an event result can be a qualitative value (e.g., “Pass,” “Fail,” or “Not Executed”), and/or a quantitative value (e.g., percentage tasks passed);

Task Results: a result of execution for each of the tasks of the segment models. For example, a task result can be a qualitative value (e.g., “Pass,” “Fail,” or “Not Executed”), and/or a quantitative value (e.g., percentage value); and

Timestamps: time/date information for the stored results. For example, timestamp information can indicate when a software development workflow process model execution started, when a software development workflow process model execution ended, as well as timestamp data for event results, segment model results, and task results.

The tool adapter records 642 may each include a variety of attributes and values associated with and/or affecting a tool adapter. In general, a tool adapter allows the system 602 (and/or parts thereof) to execute and/or otherwise communicate with some particular set(s) of tools, regardless of the tools' particular implementation and/or interface, in a consistent and/or standardized way. The tool adapter records 642 can store some or all of the following data:

Tool Adapter Identifier: an identifier (e.g., a key or UID) that identifies the stored tool adapter;

Tool Type: the type of tool. For example, tool types can include a source code repository tool, a binary repository tool, an issue tracking tool, a project management tool, and/or a code quality tool;

Tool Implementation: the particular tool implementation (e.g., Stash); and

Rule(s): one or more rules (e.g., rules 644-652) associated with the stored tool adapter.

The software development workflow process model configuration rules 644 (or, “workflow process model configuration rules”) define attributes, functions, and/or conditions for configuring and/or generating software development workflow process models. The rules 644 can specify, identify, and/or define a model (e.g., node graph model) to use for integrating, building, testing, and deploying projects and resources. The rules 644 may further define input values, output values, and dependencies for the software development workflow process model.

The rules 644 can define conditions for selecting a particular workflow process segment model when creating a software development workflow process model. For example, the rules 644 may require a particular start segment model (e.g., CI segment model) and/or a particular end segment model (e.g., PROD) when creating a particular software development workflow process model. Similarly, the rules 644 may include segment model dependencies. The rules 644 may dynamically determine which workflow process segment models are available for selection at a given point during the workflow process configuration. For example, for an “empty” workflow process, the rules 644 may only allow the CI segment model to be selected, but after the CI segment model is selected, one or more other segment models may become available for inclusion in the software development workflow process model.

The rules 644 can permit manual definition of some or all segment model dependencies within a software development workflow process model in response to user input. For example, a user may select an FT segment model, a PT segment model, and define that the PT segment model depends on the FT segment model for a particular software development workflow process model.

The rules 644 can permit automatic definition of some or all segment model dependencies within a software development workflow process model without requiring dependency-specific input from a user. For example, the rules 644 may define a set of dependencies for each segment model such that the system 602 may infer a particular dependency for a particular combination of segment models. For example, if a workflow process includes a CI segment model and an FT segment model and a PROD segment model, the rules may allow the system 602 to infer that the FT segment model depends on the CI segment model, and the PROD segment model depends on the CI segment model without requiring input from a user specifying such dependencies.

The rules 644 can define one or more sets of template software development workflow process models (or, “template models”). For example, template models can be associated with one or more objectives or requirements, e.g., (no-fault tolerance system, cloud-based system, etc.), and the rules 644 may instruct the system 602 to present particular set(s), or subset(s), of template models in response to a user input.

The rules 644 can define attributes, functions, and/or conditions for configuring and generating software development workflow process models for parallel execution of segment models, and/or parallel execution with one or more other software development workflow process models.

Parallel execution can be controlled based on parallel execution dependencies. For example, a parallel execution dependency can define that a first segment model and a second segment model can execute at the same time. Similarly, a parallel execution dependency can define that a first segment model and a second segment model can each execute as soon as their own segment model dependencies are satisfied, regardless of a status of the other segment model. For example, segment model “B” and segment model “C” can both have a segment model dependency with segment model “A” (e.g., they both require that segment model A have a passing result before executing) and neither segment model B nor segment model C have a dependency with each other, then segment model B and segment model C can each execute when segment model A provides the appropriate output (e.g., a passing result).

Parallel execution dependencies can be defined based on user input and/or without requiring user input (e.g., automatically). For example, parallel dependencies can be determined based on empirical data of a plurality of other segment model and/or software development workflow process model executions. Similarly, based on the segment model dependencies (e.g., as described in the previous example), a parallel execution can be automatically defined. Alternatively, a user can define the parallel execution during the software development workflow process model configuration process. For example, a user can select, e.g., using a GUI, multiple segment models of a software development workflow process model and indicate they should be executed in parallel.

Segment models can “wait” or “hold” based on segment model dependencies (e.g., a segment model requires an input from another segment model currently executing). For example, if a first segment model is executing in parallel with a second segment model, and a third segment model requires an input from both the first and second segment models, the third segment model can hold until it receives both inputs prior to executing.

Segment models can be configured to execute independent of one or more other segment models within a software development workflow process model. For example, a first segment model can be selected to execute independent of one or more other segment models. This can result in the first segment executing at the same time, or substantially same time, as a one or more of the other segment models. Similarly, a first software development workflow process model can be selected to execute independent of one or more other software development workflow process models. This can result in the first software development workflow process model executing at the same time, or substantially same time, as one or more of the other software development workflow process models. This can help, for example, reduce the amount of time required to integrate, test, build, and/or deploy projects or applications.

The software development workflow process segment model configuration rules 646 (or, “segment model configuration rules”) define attributes, functions, and/or conditions for configuring and generating segment models. For example, segment models can be created from template segment models and/or from scratch. In a particular embodiment, segment model attributes (e.g., segment model actions, segment model action sequences, segment model threshold conditions, segment model dependencies, etc.) can be modified, adjusted, and/or reordered. Similarly, in a particular embodiment, new model attributes can be created. The rules 646 specify, identify, and/or define a model (e.g., node graph model) for integrating, building, testing, and/or deploying projects or applications. In various embodiments, the rules 646 define input values, output values, and dependencies for the segment models.

The toolchain configuration rules 648 can define attributes, functions, and/or conditions for configuring a set of tools to generate a toolchain. The rules 648 allow the system 602 to automatically configure tools without requiring input from a user. For example, the rules 644 can include predefined configuration data for each available tool (e.g., SCM, Project Management, Binary Repository, etc. type tools).

The software development workflow process model processing rules 650 can define attributes, functions, and/or conditions pertaining to the operation, execution, management, control, maintenance, and/or administration of software development workflow process models and any corresponding workflow process runs.

Controlling execution can include (i) initiating an execution of a software development workflow process model, or portion thereof, (ii) aborting an execution of a software development workflow process model, or portion thereof, (iii) pausing an execution of a software development workflow process model, or portion thereof, (iv) skipping an execution of a software development workflow process model, or portion thereof, and/or (v) bypassing an execution of a software development workflow process model, or portion thereof. For example, while a software development workflow process model is executing, a user (e.g., via clicking a button on GUI or issuing another command) and/or system (e.g., an engine 604, 620-630 within the system 602) can pause an execution, resume a paused execution, abort an execution, skip a portion of the execution (e.g., a currently executing model segment or subsequent model segments), and/or bypass a portion of the execution (e.g., a currently executing model segment or subsequent model segments). In a particular embodiment, bypassing can include a skip operation and further provides predetermined data, such as a predetermined execution result (e.g., a pass result) and/or other value (e.g., sample code), for the bypassed portion, e.g., as if the bypassed portion actually generated the predetermined data during an actual execution.

The rules 650 can define trigger events. Trigger events can cause an execution of a software development workflow process model. For example, a trigger event may represent a particular source code commit event originating from a particular SCM repository.

The rules 650 can define workflow process control events. Workflow process control events may initiate and/or alter the control and/or execution of a software development workflow process execution (i.e. a workflow process run). In a particular embodiment, workflow process control events may be generated in response to a user interacting with a GUI (e.g., clicking a “start” icon, “stop” icon, “restart” icon, etc.), a command line interface (CLI), and/or using some other means to issue commands. In a particular embodiment, workflow process control events may be generated by the system 602, or a part thereof (e.g., by some engine 604, 620-630 within the system and/or because of particular configuration rules 644-652 in the rules database 618).

The rules 650 can define overall workflow process threshold conditions for determining whether to deploy a project or application to a production system. For example, an overall threshold workflow process condition can be a qualitative condition (e.g., “pass,” or “fail”) and/or a quantitative condition, such as greater or less than a predetermined value (e.g., 100%). Accordingly, an overall threshold condition may be satisfied if 100% of the workflow process segment models within a particular workflow process model execution are passed.

The rules 650 can define workflow process segment model threshold conditions for determining whether a software development workflow process model execution is advanced to a next workflow process segment model or terminated. For example, a workflow process segment model threshold condition can be a qualitative condition (e.g., “pass,” or “fail”) and/or a quantitative condition, such as greater or less than a predetermined value (e.g., 100%). Accordingly, a workflow process segment model threshold condition may be satisfied if 100% of the events and/or tasks within a particular workflow process segment model execution are passed.

The rules 650 can define workflow process segment model gate conditions for determining whether a software development workflow process model execution is advanced to a next workflow process segment model, terminated, or held. The gate condition can be in addition to, or instead of, other conditions (e.g., workflow process segment model threshold conditions). For example, a gate condition may require an administrator, or other user with sufficient privileges, to approve a workflow process advancement prior to actually advancing an execution of the software development workflow process model. For example, a PROD segment model may require an administrator to approve application deployment prior to deploying the application to a production system.

A workflow process segment can include one or more quality gate conditions, and/or quality gate conditions can include different condition types. For example, a workflow process segment can include one or more quality gate conditions, and the condition types can include critical conditions, non-critical conditions, and/or the like. Each condition type can be associated with a threshold value and/or value range (collectively, “value”). For example, critical condition types may be associated with a 100% pass rate in order for the software development workflow process model to advance to the next workflow process segment, while a non-critical condition type may be associated with a 90% pass rate in order for the software development workflow process model to advance to the next workflow process segment.

The rules 650 can define events associated with workflow process segment models. For example, events may include some or all of the following:

Event ID: an identifier (e.g., a key or UID) that identifies the event;

Workflow process Segment Model: an associated segment model and/or segment model type;

Project: an associated project;

Resource: an associated resource;

Status: a status of the event execution, e.g., completed, not started, in progress;

Result: a result of the event execution, e.g., pass, fail, 90% passed, 10% failed, etc.;

Event Threshold Condition: a condition that must be satisfied for the event to pass; and

Timestamp: date/time information the event was executed.

Event attribute values can be stored in one or more databases (e.g., project database 606, resource database 608, workflow process model database 610, workflow process segment model database 612, workflow process results database 614, tool adapter database 616, and/or rules database 618).

The rules 650 can define tasks associated with workflow process segment models. For example, tasks may include some or all of the following:

Task ID: an identifier (e.g., a key or UID) that identifies the task;

Action(s): one or more actions;

Tool Type: the type of tool to perform the action;

Status: a status of the task, e.g., completed, not started, in progress, etc.;

Result: a result of the task, e.g., pass, fail, etc.;

Task Threshold Condition: a condition that must be satisfied for the task to pass; and

Timestamp: date/time information task was executed.

Task attribute values may be stored in one or more databases (e.g., project database 606, resource database 608, workflow process model database 610, workflow process segment model database 612, workflow process results database 614, tool adapter database 616, and/or rules database 618).

The rules 650 can define attributes, functions, and/or conditions for parallel execution of software development workflow process models and/or segment models. For example, a first segment model and a second segment of a single software development workflow process model can execute at the same time, or substantially same time. Similarly, a first software development workflow process model can execute at the same time, or substantially same time, as a second software development workflow process model.

The software development workflow process system configuration rules 652 (system configuration rules) define attributes, functions, and/or conditions for controlling the operation, execution, management, control, maintenance, and/or administration of the software development workflow process system 602 or portions thereof.

The system configuration rules 652 can define attributes, functions, and/or conditions for configuring a set of tools to generate a toolchain. In general, the rules 652 can allow the system 602 (and/or its constituent parts or subsystems) to operate differently conditional upon specific events, situations, configurations, etc.

The rules 652 can include flags, properties, and/or settings that enable, disable, and/or alter the operation or behavior of specific system features and/or components.

System configuration rule data may be stored in one or more databases (e.g., project database 606, resource database 608, workflow process model database 610, workflow process segment model database 612, workflow process results database 614, tool adapter database 616, and/or rules database 618).

An “engine,” “device,” “tool,” “system,” and/or “database” may comprise software, hardware, firmware, and/or circuitry. In one example, one or more software programs comprising instructions capable of being executable by a processor may perform one or more of the functions of the engines, devices, tools, systems, and/or databases described herein. In another example, circuitry may perform the same or similar functions. Alternative embodiments may include more, less, or functionally equivalent engines, devices, tools, systems, and/or databases, and still be within the scope of present embodiments. For example, as previously discussed, the functions of the various engines, devices, tools, systems, and/or databases may be combined or divided differently.

The engines described herein, or the engines through which the systems and devices described herein can be implemented, can be cloud-based engines. As used herein, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used herein, databases are intended to include repositories having any applicable organization of data, including tables, comma-separated values (CSV) files, traditional databases (e.g., SQL), or other applicable known or convenient organizational formats. Databases can be implemented, for example, as software embodied in a physical computer-readable medium on a specific-purpose machine, in firmware, in hardware, in a combination thereof, or in an applicable known or convenient device or system. Database-associated components, such as database interfaces, can be considered “part of” a database, part of some other system component, or a combination thereof, though the physical location and other characteristics of database-associated components is not critical for an understanding of the techniques described herein.

Databases can include data structures. As used herein, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The databases, described herein, can be cloud-based databases. A cloud-based database is a database that is compatible with cloud-based computing systems and engines.

Computer Implementation

Components of the embodiments disclosed herein, which may be referred to as methods, processes, applications, programs, modules, engines, functions or the like, can be implemented by configuring one or more computers or computer systems using special purpose software embodied as instructions on a non-transitory computer readable medium. The one or more computers or computer systems can be or include one or more standalone, client and/or server computers, which can be optionally networked through wired and/or wireless networks as a networked computer system.

The special purpose software can include one or more instances thereof, each of which can include, for example, one or more of client software, server software, desktop application software, app software, database software, operating system software, and driver software. Client software be configured to operate a system as a client that sends requests for and receives information from one or more servers and/or databases. Server software can be configured to operate a system as one or more servers that receive requests for and send information to one or more clients. Desktop application software and/or app software can operate a desktop application or app on desktop and/or portable computers. Database software can be configured to operate one or more databases on a system to store data and/or information and respond to requests by client software to retrieve, store, and/or update data. Operating system software and driver software can be configured to provide an operating system as a platform and/or drivers as interfaces to hardware or processes for use by other software of a computer or computer system. By way of example, any data created, used or operated upon by the embodiments disclosed herein can be stored in, accessed from, and/or modified in a database operating on a computer system.

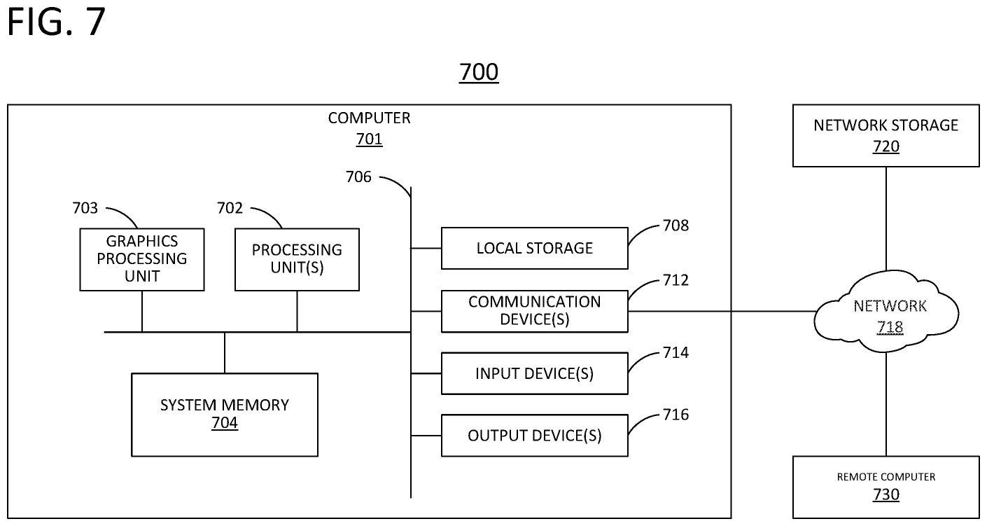

FIG. 7 illustrates a general computer architecture 700 that can be appropriately configured to implement components disclosed in accordance with various embodiments. The computing architecture 700 can include various common computing elements, such as a computer 701, a network 718, and one or more remote computers 730. The embodiments disclosed herein, however, are not limited to implementation by the general computing architecture 700.

Referring to FIG. 7, the computer 701 can be any of a variety of general purpose computers such as, for example, a server, a desktop computer, a laptop computer, a tablet computer or a mobile computing device. The computer 701 can include a processing unit 702, a system memory 704 and a system bus 706.

The processing unit 702 can be or include one or more of any of various commercially available computer processors, which can each include one or more processing cores that can operate independently of each other. Additional co-processing units, such as a graphics processing unit 703, also can be present in the computer.

The system memory 704 can include volatile devices, such as dynamic random access memory (DRAM) or other random access memory devices. The system memory 704 can also or alternatively include non-volatile devices, such as a read-only memory or flash memory.

The computer 701 can include local non-volatile secondary storage 708 such as a disk drive, solid state disk, or removable memory card. The local storage 708 can include one or more removable and/or non-removable storage units. The local storage 708 can be used to store an operating system that initiates and manages various applications that execute on the computer. The local storage 708 can also be used to store special purpose software configured to implement the components of the embodiments disclosed herein and that can be executed as one or more applications under the operating system.

The computer 701 can also include communication device(s) 712 through which the computer communicates with other devices, such as one or more remote computers 730, over wired and/or wireless computer networks 718. Communications device(s) 712 can include, for example, a network interface for communicating data over a wired computer network. The communication device(s) 712 can include, for example, one or more radio transmitters for communications over Wi-Fi, Bluetooth, and/or mobile telephone networks.

The computer 701 can also access network storage 720 through the computer network 718. The network storage can include, for example, a network attached storage device located on a local network, or cloud-based storage hosted at one or more remote data centers. The operating system and/or special purpose software can alternatively be stored in the network storage 720.

The computer 701 can have various input device(s) 714 such as a keyboard, mouse, touchscreen, camera, microphone, accelerometer, thermometer, magnetometer, or any other sensor. Output device(s) 716 such as a display, speakers, printer, or eccentric rotating mass vibration motor can also be included.

The various storage 708, communication device(s) 712, output devices 716 and input devices 714 can be integrated within a housing of the computer, or can be connected through various input/output interface devices on the computer, in which case the reference numbers 708, 712, 714 and 716 can indicate either the interface for connection to a device or the device itself as the case may be.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs can be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs).

Although the subject matter has been described in terms of certain embodiments, other embodiments, including embodiments which may or may not provide various features and advantages set forth herein will be apparent to those of ordinary skill in the art in view of the foregoing disclosure. The specific embodiments described above are disclosed as examples only, and the scope of the patented subject matter is defined by the claims that follow.

In the claims, the term “based upon” shall include situations in which a factor is taken into account directly and/or indirectly, and possibly in conjunction with other factors, in producing a result or effect. In the claims, a portion shall include greater than none and up to the whole of a thing. In method claims, any reference characters are used for convenience of description only, and do not indicate a particular order for performing a method.

1. A method performed by a computer system having at least one processor and a memory, the method comprising, the computer system:
accessing context data for an event that triggers a workflow process within a computer software development system, wherein the context data comprises an event type for the event;
accessing workflow process configuration data for a set of computer software source code, wherein the workflow process configuration data comprise software application configuration data and workflow process instructions;
modifying the workflow process configuration data to create modified workflow process configuration data, wherein the modifying comprises configuring the workflow process configuration data to implement one or more optimizations, and wherein each of the one or more optimizations is based on an evaluation of a portion of the context data; and
executing an optimized workflow process run to generate one or more software artifacts based on the modified workflow process configuration data.

2. The method of claim 1, wherein the context data further comprise an event source for the event.

3. The method of claim 1, wherein the context data further comprise an event time for the event.

4. The method of claim 1, wherein the event type is selected from the group consisting of:
a revision to software source code;
an initial configuration of the workflow process configuration data for the set of software source code;
a change of a resource upon which the set of software source code depends;
a scheduled event;
receipt of a user-supplied instruction to initiate a workflow process; and
receipt of a user-supplied instruction to restart a workflow process.

5. The method of claim 1, wherein the workflow process instructions define tasks and dependencies between tasks.

6. The method of claim 1, wherein software application configuration data comprise one or more of:
software dependency data;
configuration data for generating a software application;
configuration data for testing a software application;
configuration data for analyzing a software application;
configuration data for releasing a software application;
configuration data for deploying a software application to a particular environment; and
configuration data for deploying a software application for a particular purpose.

7. The method of claim 1, wherein each of the one or more optimizations is selected from the group consisting of:
a reordering of tasks specified to be performed by the workflow process;
a parallelization of tasks specified to be performed by the workflow process;
an omission of a task specified to be performed by the workflow process;
an inclusion of a task not specified to be performed by the workflow process;
a configuration of a task incompletely configured by the workflow process;
a reuse of an artifact produced by a previously executed workflow process;
a configuration of a software artifact not originally configured to be produced by the workflow process;
a creation or modification of scheduling parameters affecting execution of the workflow process; and
an identification or modification of resources allocated for execution of the workflow process.

8. The method of claim 1, further comprising:
determining that the event is not an ignorable event based on the context data and the modified workflow process configuration data, wherein the executing of the workflow process run is performed in response to the determining that the event is not an ignorable event.

9. The method of claim 1, wherein the context data for the event, the workflow process configuration data, or both are accessed from a database.

10. The method of claim 1, wherein the context data for the event, the workflow process configuration data, or both are received from a computer system.

11. The method of claim 1, wherein each of the generated software artifacts is selected from the group consisting of:
a set of one or more deployable software applications;
a set of one or more software dependencies;
metrics relating to the executing of the workflow process;
logs relating to the executing of the workflow process; and
reports about artifacts produced by the workflow process.

12. The method of claim 1, wherein one of the optimizations comprises:
omitting a software deployment task from the workflow process, wherein the event that triggers the workflow process comprises a revision to software source code on a non-master branch or on a feature branch.

13. The method of claim 1, wherein one of the optimizations comprises:
addition and configuration of a source code analysis task to the workflow process, wherein the source code analysis task is not specified in the workflow process configuration data prior to the modifying.

14. The method of claim 1, wherein one of the optimizations comprises:
alteration of a scheduling priority of a task in the workflow process, wherein the event that triggers the workflow process comprises a revision to software source code, and wherein the alteration is based on an evaluation of the revision.

15. The method of claim 1, wherein one of the optimizations comprises:
alteration of a scheduling priority of the workflow process, wherein the event that triggers the workflow process comprises a revision to software source code, and wherein the alteration is based on an evaluation of the revision.

16. The method of claim 1, wherein one of the optimizations comprises:
using files cached by a separate workflow process in the workflow process based on a determination that the separate workflow process is configured to perform a task identically to the workflow process.

17. The method of claim 1, wherein one of the optimizations comprises:
specifying or modifying a number, a size, or a type of computing resources used to execute the optimized workflow process run.

18. A computer system comprising at least one processor and a memory storing instructions that, when executed by the at least one processor, cause the computer system to perform the method of claim 1.

19. A non-transitory computer readable medium having instructions stored thereon, wherein the instructions, when executed by a computer system having at least one processor and a memory, cause the computer system to perform the method of claim 1.
